(19) United States
(12) Patent Application Publication
(10) Pub. No.: US 2012/0274167 A1
(43) Pub. Date: Nov. 1, 2012

(54) BRUSHLESS DC MOTOR HAVING SLOTLESS STATOR

(76) Inventors: You Jeong Kim, Daejeon (KR); Jin Ho Kim, Daejeon (KR)

(21) Appl. No.: 13/320,891

(22) PCT Filed: Aug. 19, 2010
(86) PCT No.: PCT/KR10/05485

§ 371 Date: Nov. 16, 2011

(30) Foreign Application Priority Data
Jun. 19, 2010 (KR) 10-2010-0058286

(51) Int. Cl. H02K 21/12

(52) U.S. Cl. 310/156.08

(57) ABSTRACT

The present invention relates to a brushless DC motor having a slotless stator, more particularly to a brushless DC motor having a slotless stator in that a plurality of coil winding protrusion portions capable of winding coils in a bobbin is separated from each other at regular intervals along an outer circumference surface of a body portion, so that it can wind the plurality of the coils in the longitudinal direction of a shaft, thereby supplying the DC motor of the high power; and the bobbin is made of an insulating material, so that the rotation of the rotor is not disturbed.

### TECHNICAL FIELD

The present invention relates to a brushless DC motor having a slotless stator, more particularly to a brushless DC motor having a slotless stator in that a plurality of coil winding protrusion portions capable of winding coils in a bobbin is separated from each other at regular intervals along a circumference surface of a body portion, so that it can wind the plurality of the coils in the longitudinal direction of a shaft, thereby supplying the DC motor of the high power; the bobbin is made of an insulating material, so that the rotation of the rotor is not disturbed, thereby more increasing the efficiency of the high output; and it can solve difficult problems in that the conventional manufacturing process for fabricating the coil winding body of the brushless DC motor is complicated and it is not allowed for the mass production thereof.

### BACKGROUND ART

A brushless DC motor (hereinafter, called as a BlDC) is characterized in that mechanical contacting portions called as a brush and a commutator are not existed in comparison with the conventional brush DC motor.

According to a high efficiency, a miniaturization, and a long-life of a device and a development of a semiconductor technique, parts, and material, the BLDC is widely used.

The brushless DC motor includes a rotor formed at the center of the inside thereof and a stator for covering it and allowing the rotor to rotate therein.

Generally, the electric motor includes protrusions and slots separated from each other at regular intervals along an inner circumference surface of the stator and parallel to each other in the longitudinal direction thereof and coils wound in the inside of the slots, thereby inducing the magnetic field. However, where the coils are wound in the inside of the slots, it consumes lots of energy and time and requires complicated devices. Also, since a discontinuous magnetic field is generated owing to the existence of the protrusions and the winding numbers are restricted, there is a defect in that the motor is inefficient.

Accordingly, in order to solve the above problems, the coils are filled into the entire area of the stator and the number of the effective conductor for the motor is ensured, so that the efficiency thereof is increased and the hysteresis loss is decreased. That is, a winding core of a hexagonal shape, in that two sides thereof is longer than other side in length, is provided, so that the coils of three pieces are wound around the outer surface of the winding core and then, the winding core is removed.

Here, after the winding core is removed, the coils molded in the shape of the winding core is obliquely pressed, the coils is flattened and overlapped over again.

Then, both ends of the coil are overlapped and then, rolled in a circle. Thereafter, the rolled coil is molded in consideration of the diameter of the inner and outer surfaces so as to insert it into the inside of the motor and insert the rotor therein, thereby completing the coil winding body for stator.

In this coil winding body for stator, since the protrusions and slots are not formed on the stator and the coils are filled into the entire area of the stator, it can accomplish the improvement in efficiency of the motor. However, the error rate is high and it requires precise and special devices for decreasing the error rate thereof.

That is, in the process of pressing the coils flat after the coils are wound around the winding core, the coils can get tangled without maintaining an even winding status. This result can be devastating effects in terms of the motor efficiency. Also, in the process of molding it in the shape of a circular shape, since the inner and outer diameters thereof are not even after the molding, it requires separate device and process for setting the demanded sizes of the inner and outer diameters before assembling of the completed product.

From these problems described in the above technique, even though it has a merit capable of improving the motor efficiency, since the production efficiency is bad owing to a waste in terms of a time, a labor force, and a device etc., the manufacturing and the usage thereof is not invigorated.

Accordingly, it has demanded techniques capable of providing a manufacturing convenience and supplying a DC motor of a high power in terms of a slotless stator.

### DISCLOSURE

### Technical Problem

Therefore, the present invention has been made in view of the above-mentioned problems, and an object of the present invention is to provide a brushless DC motor having a slotless stator in that a plurality of coil winding protrusion portions capable of winding coils through the slotless stator without a slot of causing a cogging torque is separated from each other at regular intervals along an outer circumference surface of a body portion.

Another object of the present invention is to provide a brushless DC motor having a slotless stator in that it can wind the plurality of the coils in the longitudinal direction of a shaft, thereby supplying the DC motor of the high power.

Further another object of the present invention is to provide a brushless DC motor having a slotless stator in that the bobbin is made of an insulating material, so that the rotation of the rotor is not disturbed, thereby more increasing the efficiency of the high output.

Further another object of the present invention is to provide a brushless DC motor having a slotless stator in that it can solve difficult problems in that the conventional manufacturing process for fabricating the coil winding body of the brushless DC motor is complicated and it is not allowed for the mass production thereof, thereby providing the simplicity of the manufacturing process and the mass productivity thereof.

### Technical Solution

In accordance with the present invention to achieve the object thereof, there is provided a brushless DC motor having a slotless stator comprising: a rotor comprising a rotor shaft and a magnet portion formed on an outer circumference surface of the rotor shaft and having at least one pair of north and south poles arranged alternately at regular intervals; a bobbin comprising a body portion having a through hole for inserting a rotor therein, a plurality of coil winding protrusion portions for winding coils longitudinally separated from each other at regular intervals along an outer circumference surface of the body portion, and two fixing protrusion portions protruded from both ends of each coil winding protrusion portion so as to be inserted and fixed into recess portions of a first insulator and a second insulator; and the first insulator and the second insulator having the recess portions respectively so as to insert the fixing protrusion portions formed on the bobbin therein.

### Advantageous Effects

According to the brushless DC motor having the slotless stator, there is an effect in that the plurality of coil winding protrusion portions capable of winding the coils through the slotless stator without the slot of causing the cogging torque is separated from each other at regular intervals along a circumference surface of a body portion.

There is another effect in that it can wind the plurality of the coils in the longitudinal direction of a shaft, thereby supplying the DC motor of the high power.

There is further another effect in that the bobbin is made of an insulating material, so that the rotation of the rotor is not disturbed, thereby more increasing the efficiency of the high output.

There is further another effect in that it can solve difficult problems in that the conventional manufacturing process for fabricating the coil winding body of the brushless DC motor is complicated and it is not allowed for the mass production thereof, thereby providing the simplicity of the manufacturing process and the mass productivity thereof.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is an exploded perspective view illustrating a brushless DC motor having a slotless stator according to one embodiment of the present invention;

FIG. 2 is a perspective view illustrating a bobbin and an insulator of a brushless DC motor having a slotless stator according to one embodiment of the present invention;

FIG. 3 is a perspective view illustrating a brushless DC motor having a slotless stator according to one embodiment of the present invention; and

FIG. 4 is a planar view illustrating a status in that a rotor is inserted into an inside of a bobbin of a brushless DC motor having a slotless stator according to one embodiment of the present invention.

### DESCRIPTION ON REFERENCE NUMBERS FOR THE MAJOR COMPONENTS IN THE DRAWINGS

100: rotor
110: rotor shaft
120: magnet portion
200: bobbin
210: through hole
220: body portion
230: coil winding protrusion portion
240: fixing protrusion portion
300: coil
400: first insulator
400a: second insulator
410: recess portion
500: housing
510: bobbin through hole
520: housing groove
530: cover coupling protrusion portion
600: front cover
600a: rear cover
610: cover groove
620: clip groove
700: outside clip

### BEST MODE

### Mode for Invention

In accordance with the one embodiment of present invention to achieve the object thereof, there is provided a brushless DC motor having a slotless stator comprising: a rotor comprising a rotor shaft and a magnet portion formed on an outer circumference surface of the rotor shaft and having at least one pair of north and south poles arranged alternately at regular intervals; a bobbin comprising a body portion having a through hole for inserting a rotor therein, a plurality of coil winding protrusion portions for winding coils longitudinally separated from each other at regular intervals along a circumference surface of the body portion, and two fixing protrusion portions protruded from both ends of each coil winding protrusion portion so as to be inserted and fixed into recess portions of a first insulator and a second insulator; and the first insulator and the second insulator having the recess portions respectively so as to insert the fixing protrusion portions formed on the bobbin therein.

In accordance with another embodiment of present invention to achieve the object thereof, there is provided a brushless DC motor having a slotless stator comprising: a rotor comprising a rotor shaft and a magnet portion formed on an outer circumference surface of the rotor shaft and having at least one pair of north and south poles arranged alternately at regular intervals; a bobbin comprising a body portion having a through hole for inserting a rotor therein, a plurality of coil winding protrusion portions for winding coils longitudinally separated from each other at regular intervals along a circumference surface of the body portion, and two fixing protrusion portions protruded from both ends of each coil winding protrusion portion so as to be inserted and fixed into recess portions of a first insulator and a second insulator; the first insulator and the second insulator having the recess portions respectively so as to insert the fixing protrusion portions formed on the bobbin therein; and a housing having a bobbing through hole for inserting the bobbin therein.

Here, the plurality of the coil winding protrusion portions is parallel to the longitudinal direction of the rotor shaft.

Here, the coils are wound parallel with the longitudinal direction of the rotor shaft.

Here, the bobbin is made of an insulating material.

Here, the housing further comprises a plurality of housing grooves separated from each other at regular intervals along an inner circumference surface of the housing and parallel to each other in the longitudinal direction of the rotor shaft and the plurality of coil winding protrusion portions is inserted and fixed into the plurality of the housing grooves.

In the meantime, in the brushless DC motor having a slotless stator having a bobbin according to the present invention, the bobbin comprises a body portion having a through hole for inserting a rotor therein; and a plurality of coil winding protrusion portions for winding coils longitudinally separated from each other at regular intervals along a circumference surface of the body portion.

Here, the bobbin further comprises two fixing protrusion portions protruded from both ends of each coil winding protrusion portion so as to be inserted and fixed into recess portions of a first insulator and a second insulator.

Here, the bobbin is made of an insulating material.

In the meantime, the brushless DC motor having a slotless stator having a bobbin according to the present invention comprises: a slotless stator comprising a core having a through hole at a center thereof and at least one pair of coil arranged at regular intervals in the circumferential direction of the core and wound along the core, the slotless made of an insulating material; a rotor having a magnet portion formed on an outer circumference surface thereof and having at least one pair of north and south poles arranged alternately at regular intervals in the circumferential direction thereof, the magnet portion being formed at an inside of the slotless stator so as to be rotated against an inner circumference surface of the slotless stator; and a bobbin comprising a body portion having a through hole for inserting a rotor therein; and a plurality of coil winding protrusion portions for winding coils longitudinally separated from each other at regular intervals along a circumference surface of the body portion.

Here, the bobbin further comprises two fixing protrusion portions protruded from both ends of each coil winding protrusion portion so as to be inserted and fixed into recess portions of a first insulator and a second insulator.

Hereinafter, exemplary embodiments of the present invention will be described in detail with reference to the accompanying drawings.

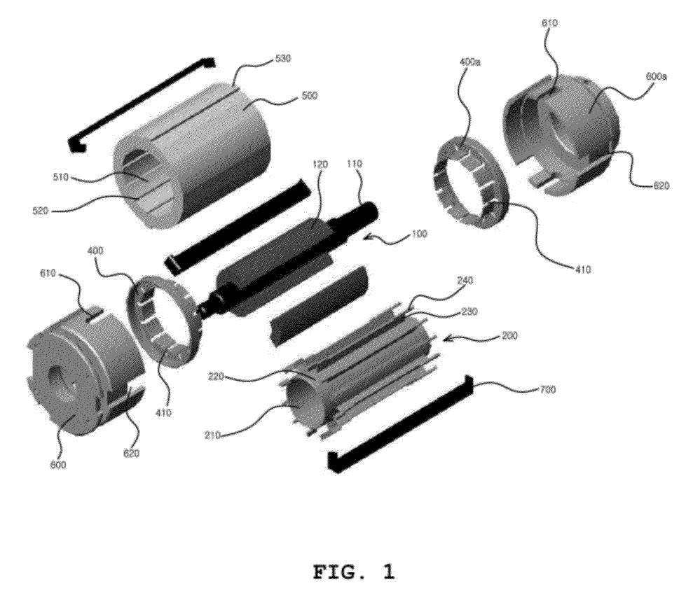

FIG. 1 is an exploded perspective view illustrating a brushless DC motor having a slotless stator according to one embodiment of the present invention.

FIG. 2 is a perspective view illustrating a bobbin and an insulator of a brushless DC motor having a slotless stator according to one embodiment of the present invention.

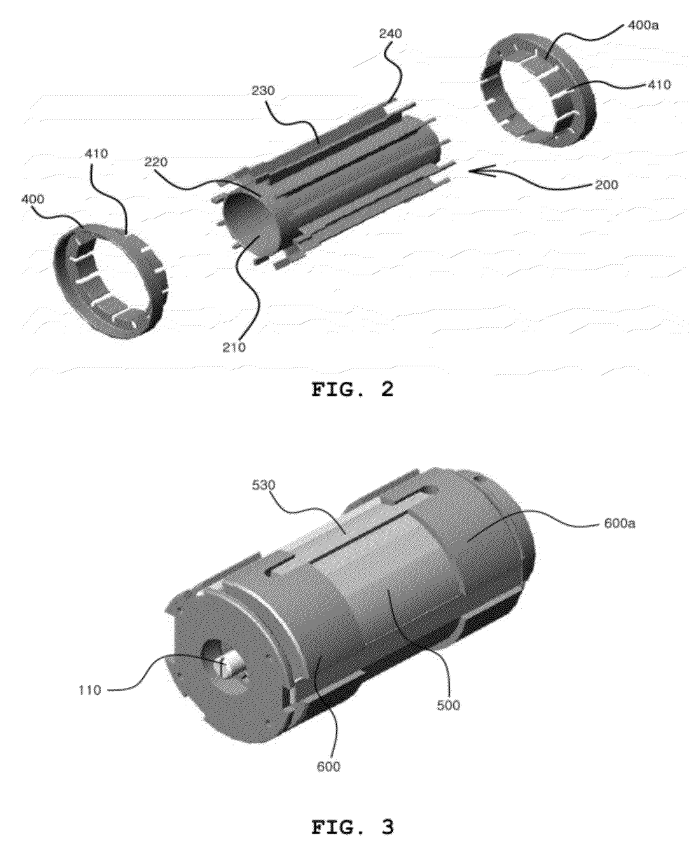

FIG. 3 is a perspective view illustrating a brushless DC motor having a slotless stator according to one embodiment of the present invention.

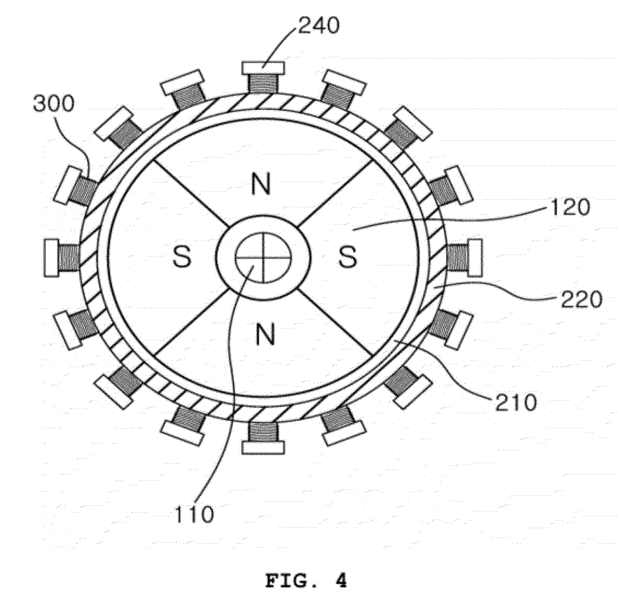

FIG. 4 is a planar view illustrating a status in that a rotor is inserted into an inside of a bobbin of a brushless DC motor having a slotless stator according to one embodiment of the present invention.

As mentioned in the prior art, the present invention is provided with the bobbin having a plurality of coil winding protrusion portions as a component of a slotless stator, thereby providing a manufacturing convenience and supplying a DC motor of a high power.

That is, as shown in FIG. 2 and FIG. 4, the bobbin 200, which is most important component in the present invention, includes a body portion 220 having a through hole 210 for inserting a rotor 100 therein, a plurality of coil winding protrusion portions 230 for winding coils 300 longitudinally separated from each other at regular intervals along an outer circumference surface of the body portion 200, two fixing protrusion portions 240 protruded from both ends of each coil winding protrusion portion so as to be inserted and fixed into recess portions 410 of a first insulator 400 and a second insulator 400a.

In the bobbin having the above construction, the plurality of the coil winding protrusion portions 230 is separated from each other at regular intervals along the circumference surface of the body portion 200, so that it can wind the plurality of the coils 300 in the longitudinal direction of a rotor shaft 110, thereby supplying the DC motor of the high power.

As shown, the plurality of the coil winding protrusion portions 230 is protruded along the circumference surface of the body portion 200 and is parallel to each other in the longitudinal direction of the body portion 220.

The plurality of the coils 300 winds around the coil winding protrusion portions 230. However, in order to prevent the wound coils 300 from being lost to outside, two fixing protrusion portions 240 are formed at both ends of each coil winding protrusion portion 230.

As described above, two fixing protrusion portions 240 are formed at both ends of each coil winding protrusion portion 230, so that the spaces for winding the coils 300 are generated between the circumference surface of the body portion 200 and the fixing protrusion portions 240, thereby stably winding the coils 300.

Since the fixing protrusion portions 240 are inserted and fixed into recess portions 410 of the first insulator 400 and the second insulator 400a, it can prevent the bobbin 200 from being running idle during the rotation of the rotor 100.

Also, the bobbin 200 is made of an insulating material. For example it can be made of a plastic material. As shown, the bobbin 200 can be manufactured by an injection-molding, so that the rotation of the rotor 100 is not disturbed, thereby more increasing the efficiency of the high output. Also, it can solve the difficult problem in that the conventional manufacturing process for fabricating the coil winding body of the brushless DC motor is complicated and it is not allowed for the mass production thereof, thereby providing the simplicity of the manufacturing process and the mass productivity thereof.

In order to manufacture the conventional coil winding body, it provides the stator coil winding apparatus for the brushless motor including a winding drum having a diameter for the inside diameter of the stator, to which the rotor is rotated, and a reaction hole penetrated therethrough, a plurality of incision grooves formed in lengths at a predetermined angle at both ends thereof, latching pins formed at each incision groove, and reaction pins inserted into each latching pin.

That is, in the conventional stator coil winding apparatus for the brushless motor, after the coil winding body is manufactured by means of the winding apparatus, the coil winding body is again coupled to an outside housing. However, as though the coils are wound by a person or a machine, the winding numbers can be exactly set. Also, there is a problem in that the degree of accuracy is remarkably deteriorated owing to the deviation thereof.

Moreover, in the conventional stator coil winding apparatus for the brushless motor, where the coils wind around the latching pins and the reaction pins are separated, only coils are separated. Also, the coils are inserted into the housing by means of a coil sizing shaft and then, an epoxy is applied therein to be cured at high temperature so as to fix the coils to the housing. Thereafter, the coil sizing shaft is essentially removed from the housing.

Accordingly, the conventional manufacturing process is complicated and it is not allowed for the mass production thereof.

In the meantime, the first insulator 400 and the second insulator 400a include the recess portions 410 respectively so as to insert the fixing protrusion portions 240 formed on the bobbin 200 therein.

It is natural that the interval between the recess portions is the same as that of the fixing protrusion portion.

In the meantime, the slotless stator of the brushless DC motor according to the present invention can include the bobbin 200 and the housing 500. Also, it can include the bobbin 200, the housing 500, and the insulators 400 and 400a.

As shown in FIG. 1 and FIG. 3, the brushless DC motor having the slotless stator according to the present invention includes a rotor 110 having a rotor shaft 110 and a magnet portion 120 formed on an outer circumference surface of the rotor shaft 110 and having at least one pair of north and south poles arranged alternately at regular intervals; a bobbin 200 having a body portion 220 having a through hole 210 for inserting a rotor 100 therein, a plurality of coil winding protrusion portions 230 for winding coils 300 longitudinally separated from each other at regular intervals along a circumference surface of the body portion 200, and two fixing protrusion portions 240 protruded from both ends of each coil winding protrusion portion so as to be inserted and fixed into recess portions 410 of a first insulator 400 and a second insulator 400a; the first insulator 400 and the second insulator 400a having the recess portions 410 respectively so as to insert the fixing protrusion portions 240 formed on the bobbin 200 therein; and a housing 500 having a bobbing through hole 510 for inserting the bobbin 200 therein.

The entire construction of the brushless DC motor having the slotless stator according to the present invention includes a rotor 100 having a rotor shaft 110 and a magnet portion 120 formed on an outer circumference surface of the rotor shaft 110 and having at least one pair of north and south poles arranged alternately at regular intervals; a bobbin 200 for inserting the rotor shaft 110 into the through hole 210; the first insulator 400 and the second insulator 400a having the recess portions 410 respectively so as to insert the fixing protrusion portions 240 formed on the bobbin 200 therein; the housing 500 having the bobbing through hole 510 for inserting the bobbin 200 therein; a front cover 600 and a rear cover 600a coupled to both sides of the housing 500 respectively; and outside clips 700 for firmly fixing the housing 500 and the front and rear covers 600 and 600a thereto so as to prevent the parts from being deviated.

The housing 500 includes the bobbing through hole 510 for inserting the bobbin 200 therein and a cover coupling protrusion portion 530 for combining the front and rear covers 600 and 600a.

The housing 500 further includes a plurality of housing grooves 520 separated from each other at regular intervals along an inner circumference surface of the housing body portion 200 and parallel to each other in the longitudinal direction of the rotor shaft 110. The plurality of the housing grooves 520 serves to insert and fix the plurality of coil winding protrusion portions 230 of the bobbin 200 therein.

The front cover 600 and the rear cover 600a are coupled to both sides of the housing 500 respectively. Also, the front cover 600 and the rear cover 600a include a hole for penetrating the rotor shaft 110 therethrough formed at the center thereof.

Also, the brushless DC motor having the slotless stator according to the present invention includes the outside clips 700 for firmly fixing the housing 500 and the front and rear covers 600 and 600a thereto so as to prevent the parts from being deviated.

The front cover 600 and the rear cover 600a further include a clip groove 620 for inserting and fixing the outside clips 700 therein.

The housing 500 is generally made of a silicon steel. Since the operation of the motor is widely well-known in the art, further description on this is omitted here.

In the meantime, the plurality of the coil winding protrusion portions 230 is parallel to the longitudinal direction of the rotor shaft. Accordingly, the coils can be wound parallel with the longitudinal direction of the rotor shaft.

From the above construction, the present invention is to provide a brushless DC motor having a slotless stator in that a plurality of coil winding protrusion portions capable of winding coils through the slotless stator without a slot of causing a cogging torque is separated from each other at regular intervals along a circumference surface of a body portion.

Also, the present invention is to provide a brushless DC motor having a slotless stator in that it can wind the plurality of the coils in the longitudinal direction of a shaft, thereby supplying the DC motor of the high power.

Moreover, the present invention is to provide a brushless DC motor having a slotless stator in that the bobbin is made of an insulating material, so that the rotation of the rotor is not disturbed, thereby more increasing the efficiency of the high output.

Furthermore, the present invention is to provide a brushless DC motor having a slotless stator in that it can solve difficult problems in that the conventional manufacturing process for fabricating the coil winding body of the brushless DC motor is complicated and it is not allowed for the mass production thereof, thereby providing the simplicity of the manufacturing process and the mass productivity thereof.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention is to provide a brushless DC motor having a slotless stator in that a plurality of coil winding protrusion portions capable of winding coils through the slotless stator without a slot of causing a cogging torque is separated from each other at regular intervals along a circumference surface of a body portion, thereby effectively utilizing it in the field of the DC motor.

1. A brushless DC motor having a slotless stator comprising:
a rotor comprising a rotor shaft and a magnet portion formed on an outer circumference surface of the rotor shaft and having at least one pair of north and south poles arranged alternately at regular intervals;
a bobbin comprising a body portion having a through hole for inserting a rotor therein, a plurality of coil winding protrusion portions for winding coils longitudinally separated from each other at regular intervals along an outer circumference surface of the body portion, and two fixing protrusion portions protruded from both ends of each coil winding protrusion portion so as to be inserted and fixed into recess portions of a first insulator and a second insulator; and
the first insulator and the second insulator having the recess portions respectively so as to insert the fixing protrusion portions formed on the bobbin therein.

2. A brushless DC motor having a slotless stator comprising:
a rotor comprising a rotor shaft and a magnet portion formed on an outer circumference surface of the rotor shaft and having at least one pair of north and south poles arranged alternately at regular intervals;
a bobbin comprising a body portion having a through hole for inserting a rotor therein, a plurality of coil winding protrusion portions for winding coils longitudinally separated from each other at regular intervals along an outer circumference surface of the body portion, and two fixing protrusion portions protruded from both ends of each coil winding protrusion portion so as to be inserted and fixed into recess portions of a first insulator and a second insulator;
the first insulator and the second insulator having the recess portions respectively so as to insert the fixing protrusion portions formed on the bobbin therein; and
a housing having a bobbing through hole for inserting the bobbin therein.

3. A brushless DC motor having a slotless stator as recited in claim 1, wherein the plurality of the coil winding protrusion portions is parallel to the longitudinal direction of the rotor shaft.

4. A brushless DC motor having a slotless stator as recited in claim 1, wherein the coils are wound parallel with the longitudinal direction of the rotor shaft.

5. A brushless DC motor having a slotless stator as recited in claim 1, wherein the bobbin is made of an insulating material.

6. A brushless DC motor having a slotless stator as recited in claim 2, wherein the housing further comprises a plurality of housing grooves separated from each other at regular intervals along an inner circumference surface of the housing and parallel to each other in the longitudinal direction of the rotor shaft and the plurality of coil winding protrusion portions is inserted and fixed into the plurality of the housing grooves.

7. (canceled)

8. A brushless DC motor having a slotless stator having a bobbin, the bobbin comprising:
a body portion having a through hole for inserting a rotor therein;
a plurality of coil winding protrusion portions for winding coils longitudinally separated from each other at regular intervals along an outer circumference surface of the body portion; and
two fixing protrusion portions protruded from both ends of each coil winding protrusion portion so as to be inserted and fixed into recess portions of a first insulator and a second insulator.

9. (canceled)

10. (canceled)

11. (canceled)

12. A brushless DC motor having a slotless stator as recited in claim 2, wherein the plurality of the coil winding protrusion portions is parallel to the longitudinal direction of the rotor shaft.

13. A brushless DC motor having a slotless stator as recited in claim 2, wherein the coils are wound parallel with the longitudinal direction of the rotor shaft.

14. A brushless DC motor having a slotless stator as recited in claim 2, wherein the bobbin is made of an insulating material.
